(19) United States
(12) Patent Application Publication
(10) Pub. No.: US 2002/0109646 A1
(43) Pub. Date: Aug. 15, 2002

(54) Method and apparatus for the customer-oriented use of identification systems

(76) Inventor: Werner Brauweiler, Duren (DE)

Correspondence Address: Kevin W. Guynn, SONNENSCHEIN NATH & ROSENTHAL, Wacker Drive Station, Sears Tower, P.O. Box #061080, Chicago, IL, 60606-1080, US

(21) Appl. No.: 09/970,560

(22) Filed: Oct. 4, 2001

(30) Foreign Application Priority Data
Feb. 14, 2001 (DE) 101 06 725.9
Mar. 17, 2001 (DE) 101 13 144.5
May 2, 2001 (DE) 101 21 464.2

(51) Int. Cl. G09G 5/00

(52) U.S. Cl. 345/1.2

(57) ABSTRACT

In order to further improve the known customer identification systems, so that the respective customer transactions may be processed even faster and with greater precision than was possible to-date, particularly in the customer-oriented service sector, the invention proposes that the customer account or the customer file stored in a computer installed for use by the customer advisor/customer counselor/sales personnel, in addition to the visual representation of the name and/or photos of the customer.

### BACKGROUND OF THE INVENTION

The invention concerns a method for the customer-oriented use of an electronic identification system, where electronically stored data relating to individuals are captured by a reading device and are processed by a computer. The invention also concerns the apparatus to apply the method.

The patent application WO 00/45326 describes a system for the identification of customers, where, for example, the sales personnel in a retail establishment are informed regarding each new customer entering the establishment, even in heavy customer traffic, specifically by a chip card carried by each customer, which stores customer identification data, which are obtained without direct contact in such a way that the respective sales personnel in the retail establishment can see a representation of the customer on a video screen or display, for example as a photo and/or signature of the customer and/or announcement of the name of the customer on a loudspeaker.

Telephone systems are also known, where the call number and possibly the name of the caller are displayed for immediate identification to the recipient of the call even prior to the initiation of the phone conversation.

In both cases, there is in the customer-oriented service sector, namely in the transactional relationship between the customer on the one hand and the customer advisor/customer counselor/sales personnel on the other hand, the desire of the latter group to expand the previously known identification systems for the goal-oriented processing of customer transactions.

### SUMMARY OF THE INVENTION

Therefore, the invention is based on the objective of further expanding the known electronic customer identification systems such that the respective customer transactions may be processed even faster and with greater precision than was possible to-date, particularly in the customer-oriented service sector.

This objective is solved in this invention by the method with the measures of claim 1 and with an apparatus with the characteristics of claim 7. Advantageous further developments of the invention are listed in the respective dependent claims.

The identification system of the invention opens and displays the customer account information or the customer file in addition to the visual presentation of the name and/or the photo of the contact person or customer, where the above are stored in a computer installed for use by the customer advisor/customer counselor/sales personnel. It is advantageous that the customer account be opened automatically by the computer, because this avoids the potential errors of the present manual entry of account information and saves considerable time in the processing of customer transactions. Also, the sales personnel has another check of identity and authorization for use of the account by means of the visual comparison of the customer photo stored with the account information and the physical characteristics of the customer in person. Finally, there is also the possibility of displaying an object, such as a vehicle, real estate, furniture etc, which the customer had purchased in a previous transaction, in addition to the visual presentation of the name and/or the photo of the customer on the computer screen of the sales personnel.

An advantageous embodiment of the invention will make it feasible to display the names and/or photos of multiple customers sorted in the order of contact simultaneously on the computer screen and/or display of a portable receiver, whenever multiple customers are present. This would then require a manual keystroke to display the account information after visual selection by the sales personnel.

The personal data may be stored on the chip of a chip card carried by the customer. According to the invention, the chip is a multi function chip, where specifically no data subject to data confidentiality obligations will be stored, but rather, for example, at least one unique identification number, which is not subject to data confidentiality obligations, but which can be linked to the data stored in the computer of the computer user in question, whether retail establishment, hotel, bank, etc., with the data stored there (name, photo, customer account, customer file etc.). It is advantageous that loss of such a card, such as by theft, will not engender misuse, because the unique identification number merely enables communication with the linked computer, which is unknown to the thief.

An additional advantage of such a chip card with a multi function chip is that this chip card, by virtue of its stored unique identification number (unique worldwide), may be linked to several computers with various data, such as with various customer accounts. This would make it possible to use a single multi function chip card to call various customer accounts stored in widely varying sectors, such as banks, libraries, medical offices, hotels, retail establishments.

Because such a multi function chip card does not store the name and the photo of the customer as a data file, it is necessary to store these data in a computer. The storage of a photo will thus require that the computer is linked with a scanner or an electronic camera, whenever newly acquired data are to be added to the existing customer data. The customer data may be distributed to networked branch offices, so that the multi function chip card may then also be used in those branches, such as for bank or hotel chains etc.

In a further characteristic of the invention, the multi function chip may be incorporated into a key held by the customer, rather than in a chip card. The connection of chip to key is most advantageously designed as a permanent connection, so that the advantages of the identification system are always optimally available. In an advantageous embodiment of the invention, the chip may be housed in the handle of the key, preferably a car key or also a house key, which provides a simple connection between chip and key. However, it is also possible to house the chip in a key chain attachment or a key purse, which is then connected to the key in turn.

The characteristic of the invention, namely to connect the multi function chip to the car key and then to display not only the name of the customer, but also the license plate number and a photo of the car associated with the key, on the computer screen, generates advantages, particularly for customer service in the automobile sector.

At the time of purchase of a car (whether new or used), the purchaser will be given the car and a car key that is connected to a chip according to this invention. Whenever the car is brought into the contracting repair shop, for example for periodic maintenance, the customer account with the data relevant to the maintenance can be accessed, when the car key is handed in. While the car is in the shop, the shop personnel will always have a simple means to associate the car key with the car and its license plate, which, for example, eliminates the need to tag the car key. The chip embedded in the car key will always link the key to the corresponding car in an unambiguous manner.

Embedding the chip in the car key leads to the advantageous embodiment of the invention inasmuch as the battery in the car key (intended for the wireless signal to the central locking system) may be used to increase the transmission distance for the wireless transmission of the chip data, when the chip is connected electrically to the battery. However, it is also possible to generate this electrical power by a solar cell that generates electrical power, where a small, but sufficient, solar cell is embedded in the key handle.

It is also possible, according to the invention, to incorporate this solar cell in the key handle in addition to a battery, and then to connect the components chip, battery, and solar cell in an appropriate manner. This placement needs to take care that the side-by-side or stacked arrangement of the components, given the limited space available, neither influences (modifies) nor hampers the wireless transmission of chip card data.

The increase in transmission distance by connection to a source of electrical power is not limited to applications in car keys, but may also be used for other keys, when appropriate sources of electrical power are incorporated into such keys.

In a further embodiment of the invention, the personal electronic data may be transmitted via a telephone line and may be received and processed by the recipient of the telephone call. The data received at the initiation of the telephone call are used to open a file with data about the caller from storage units, such as a computer, either prior to lifting the receiver to answer the call or at least during the phone call, and to display, for example, a photo, a graphical representation, a customer account or a combination of the above on the screen of the recipient of the telephone call. The visual representation according to this invention may involve the monitor of a computer linked to the telephone system, where this monitor would most appropriately be placed in close proximity of the telephone of the recipient. However, it is also possible to employ an appropriately equipped telephone, such as a mobile telephone with a large display, for this use, where the presence of an adequately sized storage device would make it feasible to store the required pictorial data of the file in the telephone itself, so that it is no longer necessary to link to a computer.

The use of data during the phone call and the opening of a visual file according to this invention informs the recipient of the telephone call with a visual display of the identity of the caller and the probable reason for the call even prior to the initiation of the conversation, so that the recipient is in a better position to initiate and conduct the conversation on a more customer-directed basis. The visual file may include here, depending on the existing transactional relationships, for example, a photo of the object sold (automobile with license plate, antique furniture, real estate with address etc.), a graphical representation of the firm logo, the customer account or the customer file (particularly in the case of services, banks, insurance etc.). It is important here that the visual file is tailored to the caller and relates unambiguously to the existing business relationship.

### BRIEF DESCRIPTION OF THE DRAWINGS

Additional advantages, characteristics, and details of the invention are explained in the following by means of embodiment examples in schematic drawings. They are:

FIG. 1 illustrates a floor plan of a larger retail establishment, and

FIG. 2 illustrates a car key with an integrated chip.

### DETAILED DESCRIPTION OF THE PREFERRED EMBODIMENTS

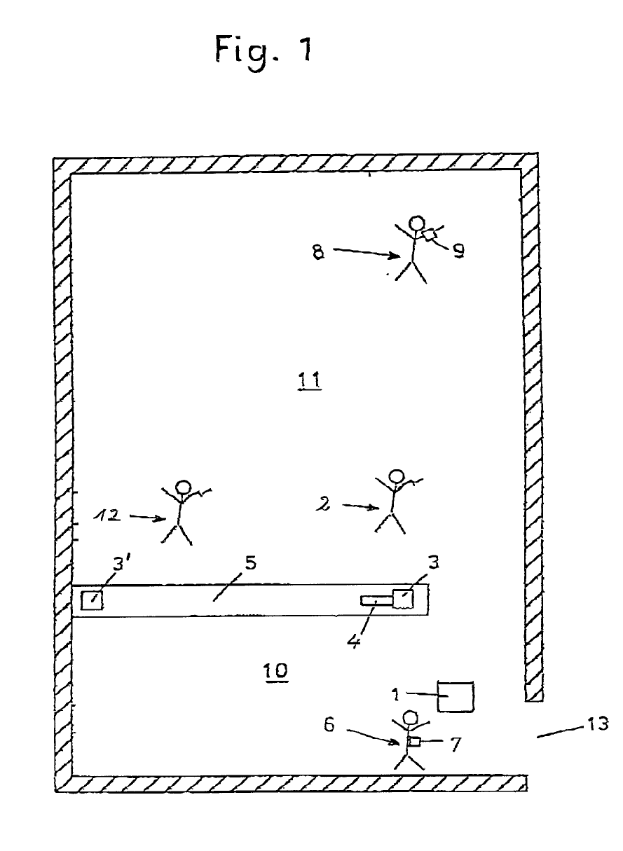

FIG. 1 shows the floor plan of a larger retail establishment 11, where a customer area 10 is separated by a sales counter 5. Two connected computers 3, 3′, each with display, and a scanner 4, which is connected to computer 3, are placed on the counter 5.

There is a chip reading module 1 in the immediate vicinity of the entrance door 13 of the customer area 10, which receives the data by wireless transmission from a chip card 7 held by the customer 6, and which transmits these by wire (not shown here) or wireless transmission to computer 3. After processing of the data, the name and/or photo of customer 6 will be displayed on the screens of computers 3 and 3′; in the case of several customers, the display of names and/or photos will be sorted in order of contact.

The sales personnel 2, 12 working behind the counter 5 may select a customer name and/or photo by a simple key stroke and thus open the associated customer account. Sales personnel 8 working in the rear of the retail establishment 11 are likewise informed via a portable unit 9 regarding arrival of the customers and their number and may then move to help out at the counter, if the need warrants. If a multi function chip card is used, it is necessary to combine the data of the customer account and the data of the customer identification file with the unique identification number, where, unless previously stored in computer 3, a photo of customer 6 is entered via scanner 4 or a digital camera (not shown) into computer 3.

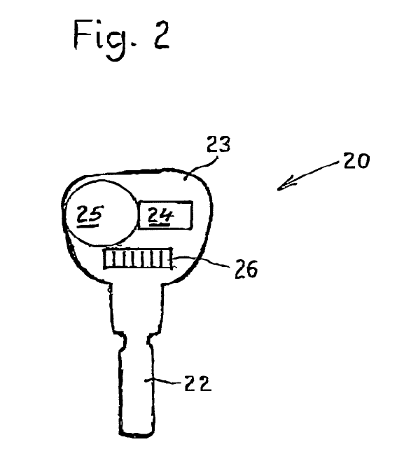

FIG. 2 shows a schematic of a car key 20. The key 20 consists of the key bit 22, which produces the locking movement, and the key handle 23 for the manual operation of the key. This key handle 23, which already includes battery 25 for the wireless operation of the central locking system of the car, also includes a chip 24 for the wireless transmission of data of the identification system. The electrical connection of chip 24 with battery 25 (the electrical connection is not shown here) serves to increase the transmission distance between the chip 24 from the reading module. In addition, the embodiment presented here includes a solar cell 26 in the key handle 23 of car key 20, which guarantees the electrical power supply of chip 24, even if battery 25 fails.

The invention is not restricted to the embodiments shown here, but may be used wherever persons may be contacted wirelessly by a chip card or by telephone data, and where this contact leads to access to a file, account etc. related to the person and stored in a computer. The specialist is here under no constraints regarding the design of the chip card and the design of the implement to handle the method according to the invention.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

I claim as my invention

1. A method for a custom oriented use of an electronic identification system, where personal data that are stored electronically are captured by a reading module and are
processed by a computer, comprising the steps of
evaluating the personal data associated with a customer,
thereafter representing customer identifying information via a display unit, and
representing customer sales information via the display unit in addition to the customer identifying information.

2. A method according to claim 1, wherein the customer identifying information comprises at least one of an image of the customer and a name of the customer.

3. A method according to claim 1, wherein the display unit provides a visual display of the information.

4. A method according to claim 1, wherein the display unit provides an audible display of the information.

5. A method according to claim 1, wherein the sales information comprises at least one of a customer account of the customer, an object associated with the customer and an identification of an object associated with the customer.

6. A method according to claim 1, comprising the further steps of storing the personal data electronically on a chip card used by the customer and wirelessly capturing the personal data for processing.

7. A method according to claim 1, comprising the further steps of transferring personal electronic data via a telephone call connection from a caller and capturing and processing the data by a recipient of the telephone call.

8. A method according to claim 7, comprising the further step of transmitting the personal data, and one of prior to an initiation of a telephone conversation and during the telephone conversation, triggering an automatic display at the location of the recipient of the customer identifying information that is stored in a computer.

9. A method according to claim 8, wherein the step of displaying the customer identifying information comprises displaying a visual display on one of a screen of a computer linked with the telephone system, on a display of an appropriately equipped telephone system and on a display of a portable receiver.

10. A method according to claim 8, where the customer identifying information comprises at least one of data, photos, customer files, and customer accounts.

11. A method according to claim 1, comprising the further step of having the account of the customer stored in a computer be opened automatically or by a key stroke simultaneously with one of a visual and acoustical representation of the customer.

12. A method according to claim 1, comprising the further step of visually displaying an identification of several customers in the order of contact with one of their name and photograph and opening corresponding customer accounts in the same order.

13. An apparatus for the customer-oriented use of an electronic identification system, comprising a multi function chip, which stores at least one unique identification number, which number is not subject to data confidentiality constraints, a reading module for evaluating the number, a computer for processing the number read by the reading module, which number is linked in the computer with customer identifying information and at least one account of the customer containing customer sales information and which number, when activated in the computer, opens the account of the customer, and a display unit for displaying customer identifying information and customer sales information stored in the computer.

14. An apparatus according to claim 13, wherein the display unit comprises at least one of a screen connected to the computer and a display of a portable receiver.

15. An apparatus according to claim 13, further comprising a linkage between a computer and one of a scanner and a digital camera, whereby a photograph of a new customer may be stored in the computer.

16. An apparatus according to claim 13, further comprising the multi function chip being located in a handle of a car key, where the chip may be connected with a power source associated with the key.

17. An apparatus according to claim 16, wherein said power source comprises one of a battery and a solar cell.

18. An apparatus according to claim 16, wherein said power source is also located in the handle of the key.

19. An apparatus according to claim 13, further comprising the multi function chip being located in a chip card carried by the customer.

20. An apparatus according to claim 13, further comprising a telephone system connected to a computer.
